(19) United States
(12) Patent Application Publication
(10) Pub. No.: US 2007/0143966 A1
(43) Pub. Date: Jun. 28, 2007

(54) Handle with vibration-reducing device

(75) Inventor: Axel Fischer, Wiedergeltingen (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/644,589

(22) Filed: Dec. 21, 2006

(30) Foreign Application Priority Data
Dec. 23, 2005 (DE) 10 2005 000 202.1

(51) Int. Cl. B25G 3/32

(52) U.S. Cl. 16/422

(57) ABSTRACT

A handle (2) of a hand-held power tool (4), includes an outer sleeve (10) to be gripped by a user, a support element (22) extending at least partially within the outer sleeve (10) along a longitudinal axis (A), a pivot attachment element (6) which at least partially is rotatable with the support element (22) and can be fixed via the handle (2) on the hand-held power tool (4), an elastic vibration-reducing device (24) which encompasses support element (22) and holds the outer sleeve (10) in a radially spaced relationship relative to the support element (22) which has an outer profile (36) with radial outer profile elevations (38) which, at least at the axial height of the vibration-reducing device (24), are arranged at a level of the radial inner profile elevations (44) of an inner profile (50) of the outer sleeve (10).

### BACKGROUND OF THE INVENTION

1. Field of the Invention

The invention relates to a handle for use on a vibration-generating hand-held power tool, such as an angular grinder, drilling hammer, or chisel hammer. The device includes an outer sleeve to be gripped by a user and a support element, which at least partially extends inside the outer sleeve along a longitudinal axis. The support element is connected with pivot means for joint rotation therewith. The pivot means can include, for example, thread means or parts of a clamp band means. With the thread means or the clamp band means, the handle can be connected by applying torque thereto with a hand-held power tool, which, for example, has a corresponding counter-thread means or receiving surface for the clamp band means. Further, the handle comprises an elastic vibration-reducing device enclosing the support element, and with which the outer sleeve is spaced radially from the support element.

2. Description of the Prior Art

Handles of the type described above, for example, are mounted when needed on hand-held power tools in order to be able to better hold and guide the tool during operation. Further, the vibration-reducing device has an insulating or damping effect, which ensures that the vibrations occurring during operation of the power tool are transmitted with a considerable reduction to the outer sleeve. This enables the power tool to be held and guided comfortably during operation.

U.S. Patent Publication US2004/0016082 A1 discloses a side handle including a pin-shaped connecting element, which is fixed via a screw connection to the housing of an angular grinder. A sleeve-shaped gripping element is held on the connecting element, with an intermediate layer therebetween which is formed of two substantially annular elastic elements. The intermediate layer ensures that a cylindrical inner surface of the gripping element is spaced from the connecting element, as a result of which a direct vibration transmission from the connecting element to the gripping element is prevented.

A disadvantage of the known side handle consists in that upon tightening or loosening the screw connection, a relatively small maximum torque can be is achieved, and the gripping element rotates relatively to the connecting element, without transmitting a rotating motion if this torque is exceeded. What is more, when the maximum torque is exceeded, the elastic elements only act as a slide bearing between the gripping element and the connecting element.

### SUMMARY OF THE INVENTION

The object of the invention is to eliminate the aforesaid disadvantages of the handle with a vibration-reducing device and to enable the transmission of a larger torque.

This and other objects of the present invention, which will become apparent hereinafter, are achieved by providing a handle, the support element of which has an outer profile with radial outer profile elevations. The outer profile elevations are arranged at least at the axial height of the vibration reducing device at the level of the radial inner profile elevations of an inner profile of the outside sleeve. Profile elevations can be formed, for example, by individual elements radially projecting from an annular base profile or by a polygonal cross-section. When using a polygonal cross-section as an outer profile, the corners of the profile act as profile elevations, compared with a virtually connected circular basic profile. When using this profile as an inner profile, the corners of the profile also correspondingly act as profile elevation, compared with a circular base profile virtually enclosing the polygonal cross-section. With the circumferentially offset profile elevations, an outer profile elevation is always arranged opposite a recessed area of the inner profile, and vice versa. Contrary to adjacent cylindrical surfaces, a toothing is realized which is effective on both radial sides of the vibration-reducing device and which produces a clearly improved torque transmission from the outer sleeve to the support element. At the same time, the support element can be spaced further towards the outer sleeve, in order to keep the transmission of vibrations as low as possible.

In a particularly advantageous embodiment of the present invention, an outer profile has an outer rotational diameter, with respect to the longitudinal axis, which is at least as large as the inner rotational diameter of the inner profile. This ensures a positive locking in the direction of rotation between the outer sleeve and the support element, which allows the transmission of a particularly large torque when tightening or loosening the pivot attachment means.

Preferably, the outer profile is formed by a cylindrical outer wall on which several axially extending outer ribs are provided. This enables a particularly simple and cost-effective production of the outer profile.

Preferably, the inner profile is formed by a cylindrical inner wall on which several axially aligned extending ribs are provided, as a result of which a particularly simple and cost-effective inner profile can be produced.

According to a particularly advantageous embodiment of the invention, the vibration-reducing device has a vibration-reducing body with a closed cross-section and which, for example, is star-shaped or undulated, and corresponds to positions of the outer profile and the inner profile. This enables to position the vibration-reducing body more easily between the two profiles. Furthermore, this type of vibration-reducing body allows to predetermine with greater precision, the preload that can be achieved during mounting by varying dimensions of the two profiles.

In a particularly preferred embodiment, the vibration-reducing body has, at least regionwise, a profile thickness which in a no-load condition is greater than a space between the outer profile and the inner profile in the corresponding regions. With mounting of the vibration-reducing body in a corresponding region, there is produced a preload that permits to adjust the vibration-reducing body particularly well in accordance with the intended method of operation of the tool in order to achieve an optimized vibration decoupling.

Preferably, the vibration-reducing device at least partially is made of foamed plastic, as a result of which costly shapes can also be produced economically.

Furthermore, it is an advantage, if the vibration-reducing device at least partially is produced on the basis of cellular polyisocyanate polyaditions. This ensures a suitable elasticity at low wear.

Preferably, the vibration-reducing device includes a vibration-reducing collar, which extends in the axial direction between a support collar held on the support element and the outer sleeve. Thereby, a vibration reduction can also be achieved in the direction of the longitudinal axis.

It is further advantageous to form the support collar at an end piece of the support element which is connected via a screw connection with the remaining portion of the support element. Consequently, the vibration-reducing device can be installed very easily.

Further, preferably the vibration-reducing collar is formed separately from the vibration-reducing body, as a result of which both elements can be produced more easily and cost effectively. Moreover, with separately formed vibration reducing collar and vibration reducing body, a material can be used, which can be adjusted to meet the requirements of both elements.

Further, it is an advantage, if at least one of the profiles is provided with a radial step, which forms an axial stop against which the vibration-reducing body can rest. This permits to prevent axial displacements of the vibration-reducing body, relative to with the support element, irrespective of the vibration-reducing collar.

Preferably, the vibration-reducing device has two vibration-reducing bodies which are provided, respectively, at two opposite ends of the handle. This enables a safe radial vibration reduction over a large length, because a parallel spring deflection is achieved as a result of the two vibration-reducing bodies being spaced from each other. In this manner, the outer sleeve can be prevented from being broken off from the support element. Further, it is sufficient when the two vibration-reducing bodies respectively extend only for a short length.

In an alternative embodiment, pivot attachment means is provided at both ends of the handle, which is connectable with the hand-held power tool. With this embodiment, the inventive handle also is useable in form of a D-shaped handle, for example, as a main handle of a hand-held power tool.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

In the drawings:

FIG. 1 shows a front elevational view of a handle according to the invention;

FIG. 2 shows a longitudinal cross-sectional view of the handle along line II-II in FIG. 1;

FIG. 3 shows a cross-sectional view of the handle along line III-III in FIG. 1;

FIG. 4 shows a perspective exploded view of the handle of FIG. 1; and

FIG. 5 shows a longitudinal cross-sectional view of another embodiment of a handle according to the present invention.

### DETAILED DESCRIPTION OF THE PREFERRED EMBODIMENTS

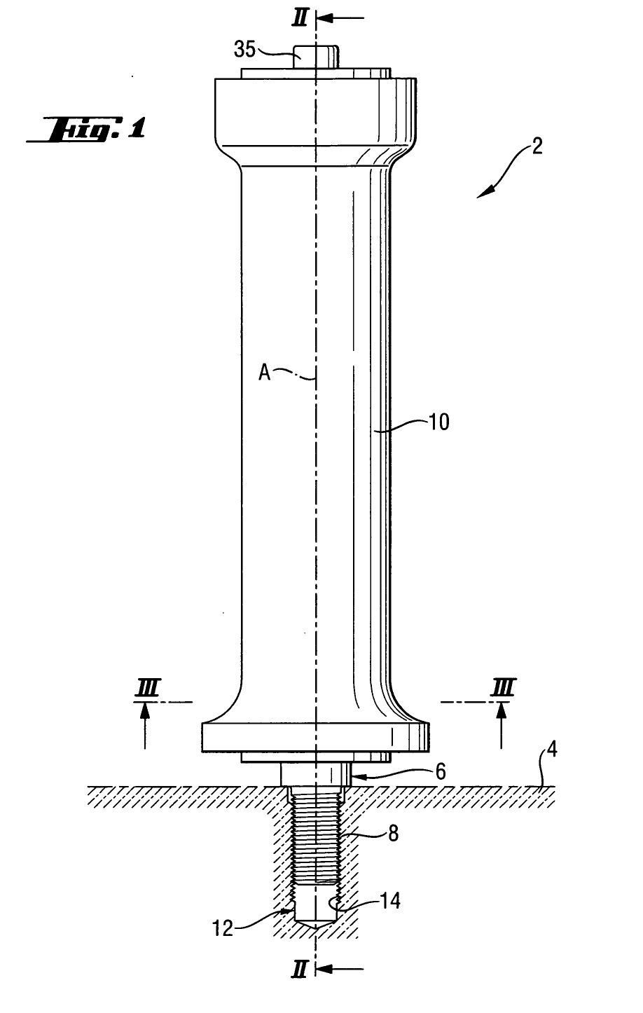

FIG. 1 shows a handle 2 in the form of a side handle, which is to be attached to an angle grinder, a drilling hammer, or a chisel hammer. For this purpose, the handle 2 has attachment means 6, which includes a thread 8 in the form of an external thread, and which is connected with the outer sleeve 10. Further, the outer sleeve 10 and the thread 8 extend along a common longitudinal axis A.

The pivot attachment means 6 is connectable with the counter-attachment means 12, which includes a counter thread 14 in the form of an internal thread provided in the hand-held power tool 4. Alternatively, the pivot attachment means 6 can also comprise commercially available clamp band means, which can be mounted on a corresponding receiving area of the hand-held power tool (not shown).

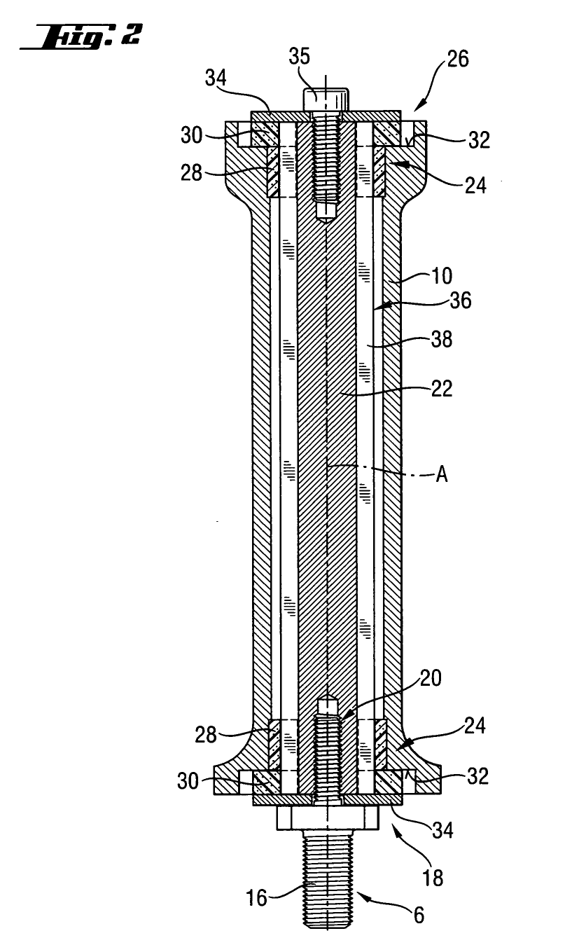

As indicated in FIG. 2, the pivot attachment means 6 is formed at an end piece 16, which is connected to the first end of the handle 2 facing the hand-held power tool 4 via a screw connection 20 with a rod-shaped support element 22. At this support element 22, the outer sleeve 10 is held by an insertion of the elastic vibration-reducing device designated with a reference numeral 24.

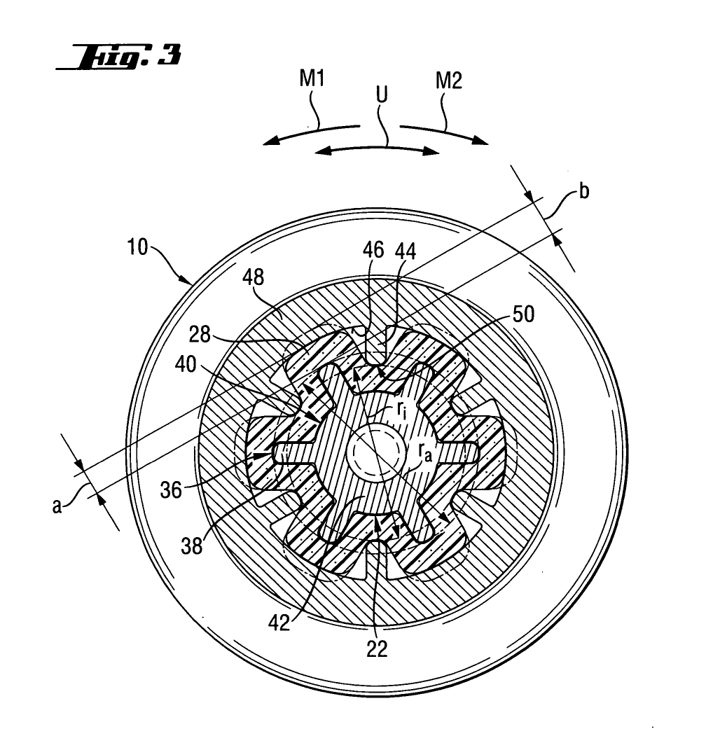

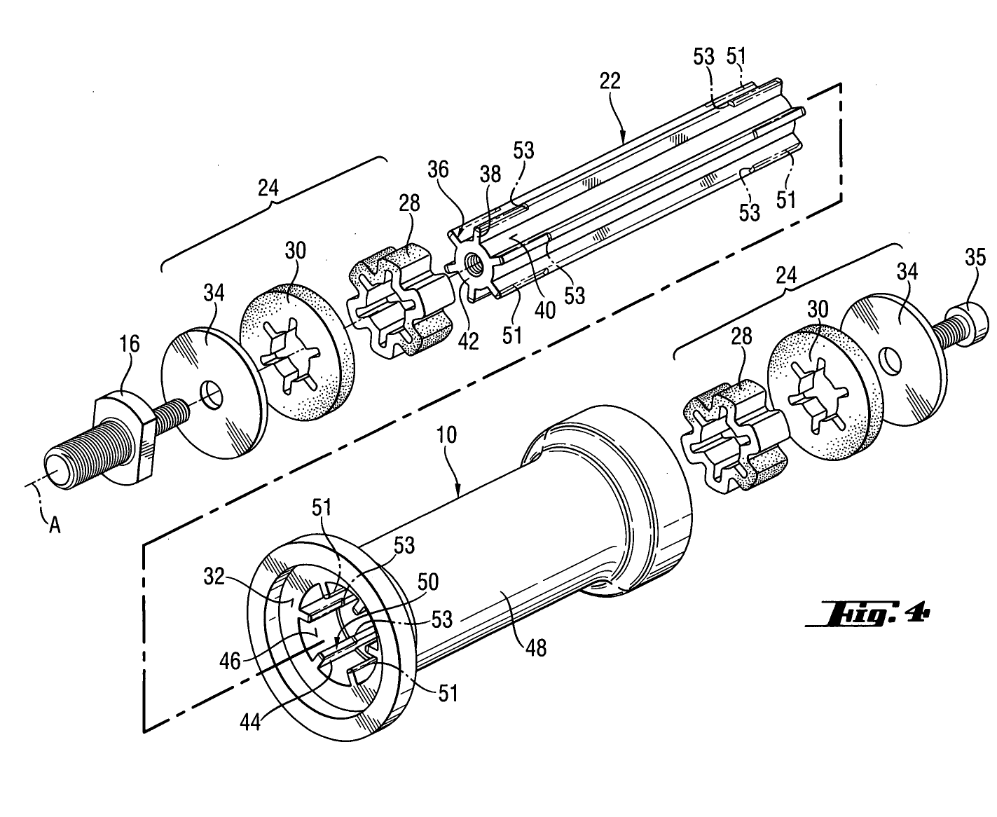

The vibration-reducing device 24 has, at each of first end 18 and at second opposite end 26 of the handle 2, a vibration-reducing body 28 made of foamed plastic based, in particular, on cellular polyisocyanate polyadditions. As is indicated in FIGS. 3 and 4, the handle vibration-reducing body 28 essentially is formed with an undulating, circular closed profile, which, when installed, encompasses the longitudinal axis A radially. Towards a respective end 18, 26, in addition to the radially acting vibration-reducing body 28, a vibration-reducing collar 30 is slid onto the support element 22, which extends radially across the cross-section of the vibration-reducing body 28 and, in this area, is arranged axially between the annular axial stop 32 of the outer sleeve 10 and a support collar 34.

In the illustrated embodiment, two support collars 34 are formed by washers, which at the first end 18 are supported by the end piece 16, and at the second end 26 by a screw 35. Alternatively, the support collar 34 can also be formed as one piece with the end piece 16 or with the screw 35, respectively, or in the above-described case, the collar 34 can be formed by using parts of a band clamp means.

Furthermore, the vibration-reducing body 28 and the vibration-reducing collar 30 at both ends 18 and 26 can also be formed as one piece as an alternative to the illustrated embodiment.

Further, as is shown in FIGS. 3 and 4, the support element 22 is formed as a spindle shaft, as a result of which the outer profile 36 is produced in which several rib-shaped radial outer profile elevations 38 project equidistantly from a cylindrical outside wall 40 of a basic body 42 of the support element 22 radially towards the outside.

In an assembled condition, these outer profile elevations 38 are arranged opposite the rib-shaped radial inner profile elevations 44 which, being equal in number and aligned with the outer profile elevations 38, radially project from a cylindrical internal wall 46 of a basic element 48 of the outer sleeve 10 towards the inside. These inner profile elevations 44 together with the inside wall 48, thus form an inner profile 50 of the outer sleeve 10.

In a two-part development of the respective vibration-reducing body 28 and vibration-reducing collar 30, as illustrated in FIG. 4, both at the outer profile 36 and at the inner profile 50, radial steps 51 can be provided in the area of the vibration-reducing body 28, which, as shown, respectively produce an axial stop 53. Consequently, the vibration-reducing bodies 28 can be arranged axially independent of the vibration-reducing collar 30, in order to prevent an axial slip on the support element 22 during operation.

As is illustrated in FIG. 3, the inner profile 50 and the outer profile 36 are spaced, at least regionwise, from each other by a distance a, which is smaller than a radial profile thickness b of the vibration-reducing device 24 in no-load condition which is indicated with dash-dot lines. This produces a preload of the vibration-reducing body 28 as a result of which the effective vibration-isolating properties of the vibration-reducing device 24, which act in the radial direction, can be adjusted. Similarly, due to the corresponding thickness of the vibration-reducing collar 30 or rather by the varying spacing of the support collar 34, compared with the respective axial stop 32 of the outer sleeve 10, the vibration-insulating characteristics of the vibration-reducing device 24 in the axial direction can be adjusted. As an alternative to the illustrated embodiment, it also is possible to dimension the profile thickness b in accordance with the spacing a, in order to arrange the vibration-reducing body 28 without a noticeable preload.

The free ends of the outer profile elevations 38 and the inner profile elevations 44 define, respectively, an outer rotational diameter ra and a inner rotational diameter ri. In this case, the outer diameter ra is at least as large as the inner diameter ri, preferably, however, is larger, in order to achieve an overlap, as shown. With the vibration-reducing body 28 in an intermediate position, this produces, in each case, a formlocking connection between the outer sleeve 10 and the support element 22 in the direction of the circumference U along the longitudinal axis A.

In order to use the handle 2, its pivot attachment means 6 is connected with the counter-attachment means 12 of the hand-held power tool 4. For this purpose, a torque M1 is applied in the circumferential direction U to the outer sleeve 10 around the longitudinal axis A. This torque M1 is transmitted by the inner profile elevations 44, in the intermediate position of the vibration-reducing body 28, to the outer profile elevations 38 of the support element 22 and from the support element 22 to the pivot attachment means 6 at the end piece 16. The above-described formlocking connection between the inner profile 50 and the outer profile 36 enables the application of a particularly high mounting torque M1 to the outer sleeve 10, without the outer sleeve 10 slipping relative to the vibration-reducing device 24. Consequently, the handle 2 can be attached particularly firmly to the hand-held power tool.

During the operation of the hand-held power tool 4, the outer sleeve 10 is held by the vibration-reducing device 24 in a spaced relationship relative to the support element 22 both in the radial and axial directions. Consequently, the vibrations generated in the hand-held power tool 4, which are transmitted via the pivot attachment means 6 to the support element 22, are transmitted merely with a severally reduced intensity to the outer sleeve 10, which provides for a particularly comfortable holding of the handle during operation.

For removing the handle 2, because of the formlocking connection between the outer profile 36 and the inner profile 50, a particularly high dismantling torque M2 can be applied in the circumferential direction U in the direction opposite the mounting. torque M1, without the outer sleeve 10 slipping relative the support element 22.

In the illustrated embodiment, the outer profile 36 extends over the entire length of the support element 22 and the inner profile 50 extends almost along the entire length of the outer sleeve 10. As an alternative, it also would be feasible to provide the two profiles 36, 50 with respect to the longitudinal axis A, only at the axial height of the vibration-reducing device 24.

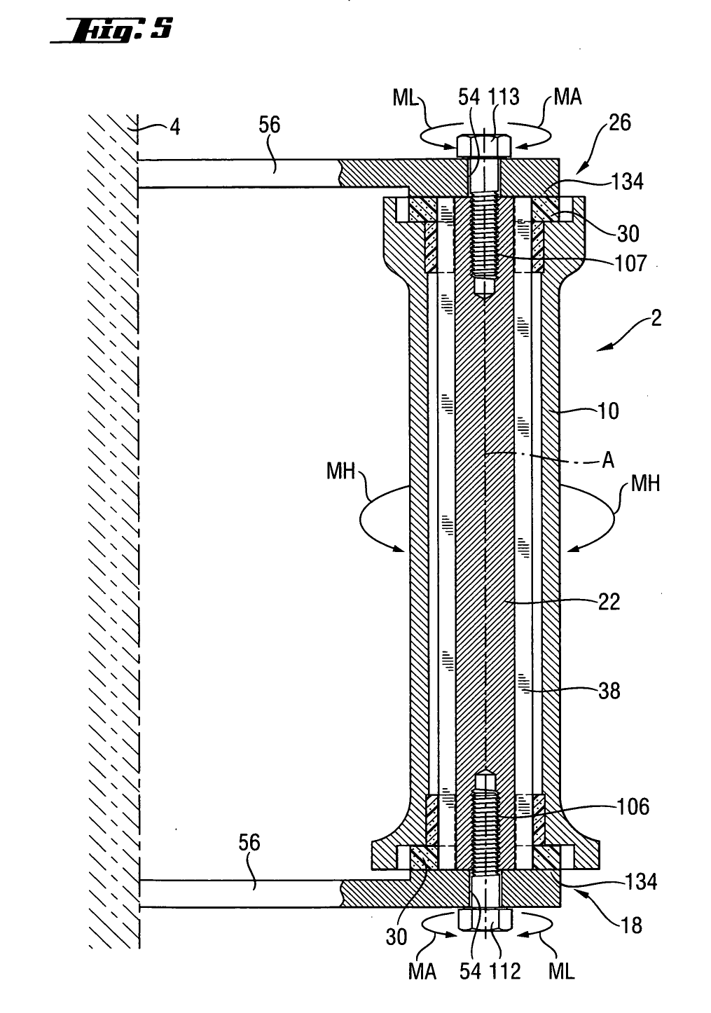

FIG. 5 shows a second embodiment of the inventive handle 2 in which parts similar to the parts of the first embodiment are designated with same reference numerals increased by 100. The handle 2 in this case is held on the hand-held power tool 4 in a D-shaped manner. With this configuration, first pivot attachment means 106 is provided at the first end 18 and second pivot attachment means 107 is provided at the second end, which are formed as threaded holes in the support element 22. Screw-shaped first counter-attachment means 112 is screwed into the first pivot attachment means 106, and the screw-shaped second counter-attachment means 113 is screwed into the second pivot attachment means 107. The counter-attachment means 112, 113 extend through a respective threaded hole 54 of a respective supporting arm 56, both of which extend from the hand-held power tool 4. The supporting arms 56 thus form a respective support collar 134 for the vibration-reducing collars 30. In other respects, the handle 4 is identical to the handle according to FIG. 1 to 4.

With this embodiment, the formlocking connection between the outer sleeve 10 and the supporting element 22 enables application of a large holding torque MH to the handle, which again allows a particularly large tightening torque MA or a particularly large loosening torque ML at the counter-attachment means 112, 113.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A handle (2) for a hand-held power tool (4), comprising:
an outer sleeve (10) to be gripped by a user and a support element (22) extending at least partially within the outer sleeve (10) along a longitudinal axis (A);
pivot attachment means (6) rotatable at least partially, with the support element (22) for securing the handle (2) on the hand-held power tool (4),
an elastic vibration-reducing device (24),surrounding the support element (22) for retaining the outer sleeve (10) in a radially spaced relationship relative to the support element (22),
wherein the support element (22) comprises an outer profile (36) with radial outer profile elevations (38), which at least at the axial height of the vibration-reduction device (24) are arranged at a level of radial inner profile elevations (44) of an inner profile (50) of the outer sleeve (10).

2. A handle as defined in claim 1, wherein an outer rotational diameter (ra) of the outer profile (36), with respect to the longitudinal axis (A), is at least as large as an inner rotational diameter (ri) of the inner profile (50).

3. A handle as defined in claim 1, wherein the outer profile (36) is formed by a cylindrical outer wall (40) on which axially extending outer ribs are formed.

4. A handle as defined in claim 1, wherein the inner profile (50) is formed by a cylindrical inner wall (46) on which axially extending inner ribs are formed.

5. A handle as defined in claim 1, wherein the vibration-reducing device (24) comprises a vibration-reducing body (28) having a closed cross-section corresponding to the outer profile (36) and the inner profile (50).

6. A handle as defined in claim 1, wherein the vibration-reducing body (28) has, at least in certain areas, a profile thickness (b) which in a no-load condition is greater than the distance (a) between the outer profile (36) and the inner profile (50) in corresponding areas.

7. A handle as defined in claim 1, wherein the vibration-reducing device (24) is made, at least partially, of a foamed plastic material.

8. A handle as defined in claim 1, wherein the vibration-reducing device (24) is formed, at least partially, on the basis of cellular polyisocyanate polyaditions.

9. A handle as defined in claim 1, wherein the vibration-reducing device (24) comprises a vibration-reducing collar (30) which extends in an axial direction between a support collar (34) held at the support element (22) and the outer sleeve (10).

10. A handle as defined in claim 9, wherein the support collar (34) is formed at an end piece (16) of the support element (22), and which is connected with a remaining portion of the support element (22) by a screw connection (20).

11. A handle as defined in claim 9, wherein the vibration-reducing collar (30) is formed separately from the vibration-reducing body (28).

12. A handle as defined in claim 11, wherein at least one of the profiles (36, 50) is provided with a radial step (51), which forms an axial stop (53) against which the vibration-reducing body (28) rests.

13. A handle as defined in claim 1, wherein the vibration-reducing device (24) comprises two vibration-reducing bodies provided at respective opposite ends (18, 26) of the handle (2).

14. A handle as defined in claim 13, wherein a pivot attachment means (106, 107) is provided at each of the opposite ends (18, 26) which are connectable with the hand-held power tool (4).
